(19) United States
(12) Patent Application Publication
(10) Pub. No.: US 2021/0034333 A1
(43) Pub. Date: Feb. 4, 2021

(54) Boolean multi-flow programming

(71) Applicant: Alexander Skabelin, New York, NY (US)

(72) Inventor: Alexander Skabelin, New York, NY (US)

(73) Assignee: Alexander Skabelin, New York, NY (US)

(21) Appl. No.: 16/531,100

(22) Filed: Aug. 4, 2019

(51) Int. Cl. G06F 8/30; G06F 8/41

(52) U.S. Cl. CPC G06F 8/30; G06F 8/41

(57) ABSTRACT

A new type of general-purpose programming is disclosed. A new method and system models a computer program as the data flowing between computational nodes that perform operations where node connections are described by Boolean functions or logical expressions. Before or during program execution the initial Boolean network of nodes and logical connections is resolved into unambiguous directed execution graph. Boolean Multi-flow method is inherently parallel and can work well in large systems. Boolean Multi-Flow programs able to analyze diverse, heterogeneous and possibly conflicting set of inputs each requiring different topologies of the underlying computational graph.

### BACKGROUND OF THE INVENTION

Programming languages and systems are classified based on their features into different programming paradigms. Common programming paradigms include functional, logical, procedural, object oriented and dataflow. The dataflow paradigm, for example, models a program as a directed graph of the data flowing between computational nodes. The node connections in this case are described for each node by a simple list of parent nodes. Dataflow programming is inherently parallel but has a limitation that underlying computational graph has fixed topology and if you need to process an input that requires a somewhat different processing you need to rewrite a significant part of the program to create a different computational graph.

Object oriented programming method packs data and functions into compact reusable blocks and achieve high degree of modularity. Object oriented method has very good data encapsulation properties but the code in this case is not easy to parallelize.

### SUMMARY OF THE INVENTION

The present invention provides a method of designing and executing computer programs. We present a novel programming paradigm—a method and system where program execution is modeled by data flowing over Boolean network where underlying computational nodes form a graph connected by Boolean functions or logical expressions. An operation implemented by computational node usually can run as soon as an acceptable set of inputs defined by the Boolean function becomes valid. The invention overcomes the limitations of the prior art such as dataflow programming where underlying computational graph has fixed topology and cannot be easily adjusted for different types of inputs. The multi-flow programming presented here can easily adjust computational graph topology to accommodate different types of input.

In one sense, this application discloses a method. According to various embodiments, the method comprises designing a computer program. The computer program comprises of computational nodes whose dependence is described by logical expressions.

In other sense, this application discloses a computer system. According to various embodiments, the computer system comprises a system configured to execute computer programs. The computer program comprises of computational nodes whose dependence is described by logical expressions.

Embodiments include, without limitation, methods for designing and executing a computer program for a computer system configured to perform such methods, and computer-readable media storing instructions that, when executed, cause a computer system to perform such methods.

Additional or alternative embodiments may be particularly or wholly implemented on a computer-readable medium, for example, by storing computer-executable instructions or modules, or by utilizing computer readable data structures.

Furthermore, the methods and systems of the above-mentioned embodiments may also include other additional elements, steps, computer-executable instructions or computer-readable data structures. In this regard, other embodiments are disclosed and claimed herein as well.

This summary is not intended to identify key or essential features of the claimed subject matter, no is it intended to be used as an aid in determining the scope of the claimed subject matter. This summary is illustrative only and is not intended to be in any way limiting.

The present invention is intended to overcome the drawbacks of the prior art. Other features and advantages of the invention will be apparent from the description, the drawings and the claims.

### DESCRIPTION OF THE DRAWINGS

FIG. 1 show non-limiting examples of a computational node in the Boolean Multi-flow system.

FIG. 2 show non-limiting examples of a Boolean Multi-flow network.

FIG. 3 show non-limiting example of a Boolean Multi-flow computation graph.

FIG. 4 show non-limiting examples of a Boolean Multi-flow program execution diagram.

FIG. 5 show non-limiting examples of the mains parts of Boolean Multi-Flow program.

FIG. 6 is a system block diagram illustrating the operating environment of example embodiments of the present invention.

FIG. 7 illustrates non-limiting example of Boolean multi-flow method.

### DETAILED DESCRIPTION OF THE INVENTION

We present a novel programming paradigm—a method and system where program execution is modeled by data flowing over Boolean network where underlying computational nodes form a graph connected by Boolean functions or logical expressions.

Boolean Multi-Flow Programming method that we introduce is parallalizable out of the box—the programmer does not need to think about data synchronization. In contrast to prior art, such as dataflow programming, Multi-flow programming is able to analyze diverse, heterogeneous and possibly conflicting set of inputs each requiring different topologies of the underlying computational graph.

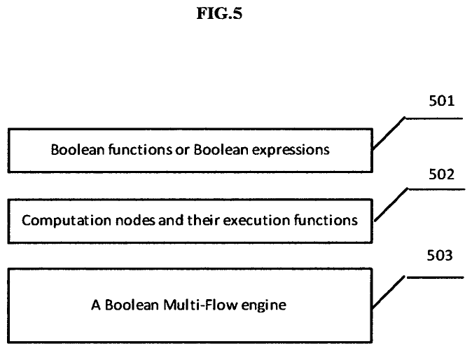

A non-limiting example of Boolean Multi-Flow program consisting of three main parts is illustrated by FIG. 5:

1) Boolean functions or Boolean expressions that describe logical dependencies of the computation nodes in 501.

2) Computation nodes and their execution functions that perform actual computations as in 502.

3) A Boolean Multi-Flow engine (work scheduler). The engine determines which nodes are ready for execution and executes them in correct order, does node bifurcation/multiplication if necessary, etc. as in 503

The above example is for illustration only, the actual Boolean Multi-flow program may also include other additional elements or have only a subset of illustrated elements.

Definitions:

Directed Boolean network (BN) is a graph G (V, E) with a set of vertices V and a set of directed edges E where each vertex Vi has an associated Boolean function Bi whose arguments are the input edges of the node “i”. The Boolean value of the node is the value of its associated Boolean function.

Restriction: The function resulting when some argument x i of a Boolean function f is replaced by a constant b is called a restriction of f, (sometimes termed a cofactor).

Control nodes(switches): nodes that do not have any parents and have unknown value.

Constant nodes: nodes that do not have any parents and have true or false value.

Scenario: any set of true/false markings of the control nodes that results in a graph with no ambiguities.

That is nodes A and B can't be both set to true in a scenario where you require to compute some node X=(A|B) which can be computed either from A OR B as there is an ambiguity from which node it will be computed.

Boolean functions or logical node dependencies can be defined and written in any suitable format or language. In nonrestrictive example, for illustration purposes only we use below an example of Domain Specific Language (DSL) that we call “Boolean language” where we use symbol “&” to represent logical AND, “|” logical OR and “!” logical NOT. In this example language symbol “=” in the expression “X=Y” means that node “X” is computable if “Y” is computable. As a result, node “Y” has to be computed before node “X”. Any other symbols representing logical operators and any subset of logical operators can be used instead.

Our example “Boolean language” representation of node dependence (such as W=((A|B)&(!H|E|K|L))|Y) can be converted into any other suitable representation. We give below a non-limiting illustration of such converter that we call “Boolean language compiler.”

### EXAMPLE : “Boolean Language Compiler”

A Boolean language compiler can read Boolean expressions and convert Boolean functions into other suitable representations. In our example a compiler is a source-to-source compiler that converts our Boolean language source code into source or data consumable by a different language—presumably the same language that is used to write the code for graph nodes. Canonical conjunctive normal form (CCNF) can be used as a nonrestrictive example of a suitable representation for Boolean functions. Other representations of Boolean functions can be used as well and within the scope of the patent. A non-limiting illustrative example of other forms is canonical disjunctive normal form (CDNF), Blake canonical form and its dual and algebraic normal form. Canonical forms are convenient as they provide a unique representation of the Boolean function. CCNF form is appropriate as Boolean functions in CCNF form like X=(A&B)|(C&D)|(!F) can be interpreted as “X is computable if (both A and B are computable) or (both C and D are computable) or (F is not computable)” where you can clearly see three computational scenarios. Any CCNF form can be represented as an array of scenarios. As compiler's output we can simply accept an array of scenarios: [scenario1, scenario2, . . . ] where each scenario is an array of two arrays [list of parent nodes, negation flag]. Here is a non-limiting illustrative example of conversion of CCNF form into array representation: (A&B)|(C&D)|(!F)→[[A,B],[0,0]], [[C,D],[0,0]], [[F],[1]]. That is in our example compiler parses Boolean functions, converts them into CCNF form, then converts CCNF form into array representation and then passes these arrays into language which you prefer to use to implement the Boolean Multi-Flow program.

Boolean functions can be written in any suitable Boolean logic. In nonrestrictive example, for illustration purposes only we present below description of the “Ternary (Three-valued) Logic.” Other Boolean two-valued, three-valued and multi-valued Logics can be used with different truth tables.

### EXAMPLE: “Logic”

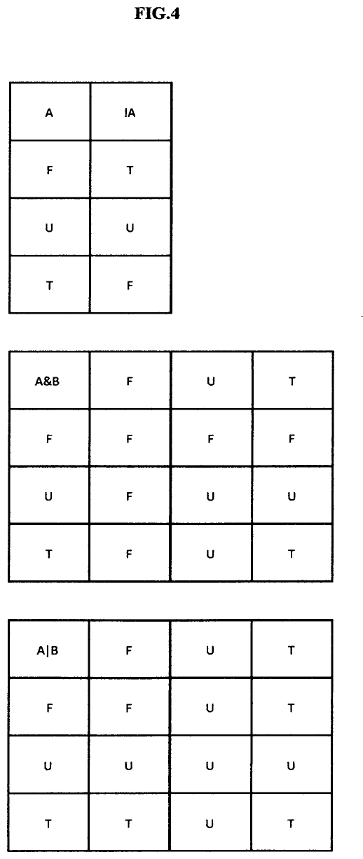

We use in this nonrestrictive example, three-valued logic where truth values indicate true, false and unknown. Two-valued and many-valued logic systems are within the scope of the invention. In our interpretation of ternary logic, the knowledge of whether any particular unknown state secretly represents true or false at any moment in time is not available. In this example our ternary logic is defined by the truth tables FIG. 4.

In contrast to Kleen and Priest ternary logic it is more convenient for us (though not necessary) to have U|T=U instead of U|T=T (and the same for T|U). T|U Boolean value for the computational node means that it can be computed but it is not known yet in how many different ways (that is dimensionality of the node is not yet fully known). That is constructs like U|T result in partially known node. It is a matter of convenience to have U|T=U which means that the node either fully unknown or completely known including node dimensionality. As a result, we will never try to compute node value for some of the node dimensions before other dimensions are known. The advantage is that we would know beforehand if the node needs name spaces as we usually put each dimension (i.e. computational scenario) in its own name space.

The program user should set control nodes (which have unknown value) in some way to true or false before program start or during program execution. As a result, all computable nodes on the Boolean network would get only true or false values and the ternary Boolean logic will collapse to a standard two-valued logic. In essence the control nodes are the program parameters that alter topology of the underlying computational graph. The program can have many other input parameters that configure the behavior of the individual nodes, but those parameters do not change the computational graph topology.

Below are a non-limiting examples of the programs that describes the logical dependencies of the computational nodes.

A Non-restrictive example of node dependence:

A=unknown

B=unknown

C=A&B

where node C is computable only if both scenarios A and B are selected to run at the same time. Node C, for example, can compare the results of node A and node B computation.

A Non-restrictive example of node dependence:

// the order of statements does not matter
// unknown nodes are switches - user will choose to set them to true or false

| | |
|---|---|
| A= unknown | // (i.e. it might be input data about US economy) |
| B= unknown | // (i.e. it might be input data about effectiveness of a medical vaccine) |
| C= true | // constant node, always executes. It can be GUI that sets all switches (i.e. A and |

B)

| | |
|---|---|
| D= A\|B | // D can be computed either from A OR B |
| F=(D&C) | // F can be computed from D AND C ( It will be executed after D and C) |
| G=!A | // G is computable only if A is NOT |

....
W= ((A|B) & (!H|E|K|L))|Y // some arbitrary Boolean function

The order of statements in this example does not matter. “Unknown” nodes are switches—a user or the program will choose to set them to true or false.

The disclosed method of programming is called “multi-flow” because the same Boolean network can run completely different data flows with different graph topologies. Different graph topologies are produced from the same Boolean network by different Boolean function restrictions. Boolean network can run different flows at the same time and compare the results. Boolean network in essence is a higher order representation—actual data flows run on its slices (restrictions).

The multi-flow programs are able to run multiple scenarios at the same time. If two scenarios S1 and S2 are selected to run at the same time, then each node can be computed either ambiguously or unambiguously. Each ambiguous node X is bifurcated into 2 nodes S 1:X and S2:X—one for each scenario. As a result, the whole computational graph become unambiguous. The names of the nodes stay unique as each scenario has its name space to resolve ambiguities. The same happens if more than two scenarios are selected. If a node is bifurcated, the number of node versions is not necessarily equal to the number of scenarios. It can be less, as some subset of scenarios (i.e. S 1 and S2) can unambiguously share the same node X without bifurcation and have a shared namespace “S1, S2” for it so that the name of the shared node is: “S1, S2:X”

A Non-restrictive Example of node bifurcation:

A= unknown
B= unknown

| | |
|---|---|
| C=A | // C is not bifurcated as it can be computed from A only |
| D =C\|B | // D is bifurcated as there are two different ways to compute it |

Assume that both switches A and B are selected, and we want to compute D then we have two scenarios as D can be computed either from A (via intermediate C) or from B.

In nonrestrictive example, for illustration purposes only we present below an example of program execution flow.

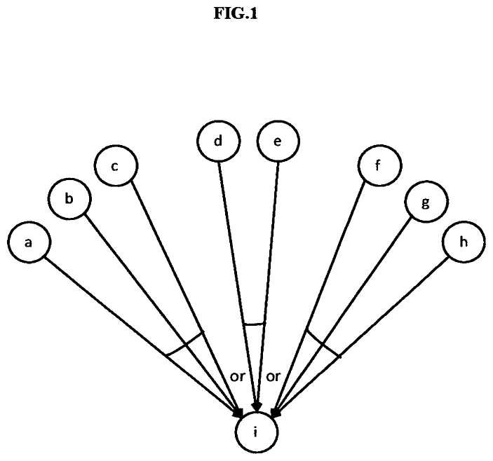

FIG. 1 show non-limiting examples of a computational node in the Boolean Multi-flow system. The node “i” need either nodes “a”, “b” but not “c” or nodes “d” but not “e” or “f”,“g”,“h” which can be described by the logical expressions (a&b&!c)|(d&!e)|(f&g&h) where we used “&” symbol as logical AND and “|” symbol as logical OR and “!” symbol as logical NOT.

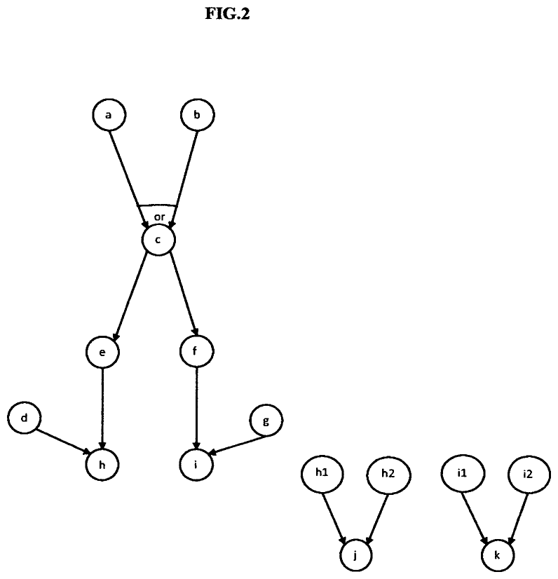

FIG. 2 show non-limiting examples of a Boolean Multi-flow network. The node “c” needs either node “a” or node “b”. Node “j” needs two versions of node “h”:“h1” and “h2”, node “k” needs two versions of node “i”:“i1” and “i2”

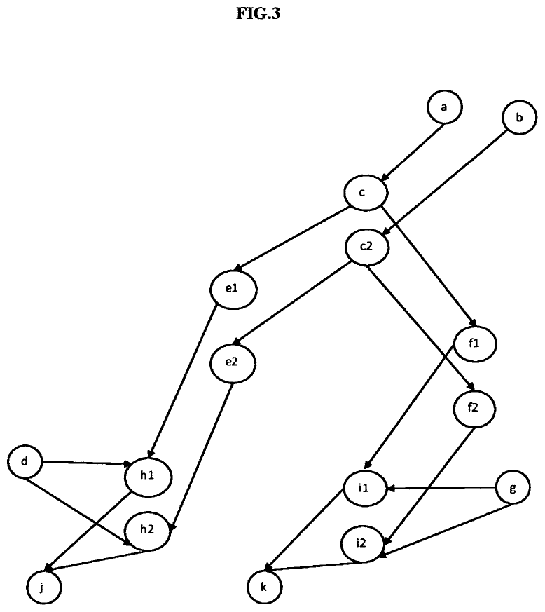

FIG. 3 show non-limiting example of a Boolean Multi-flow computation graph that would result from Boolean network in FIG. 2 if both nodes “a” and “b” are available and computable. This figure illustrates node replication in the network. If both nodes “a” and “b” on FIG. 2 are available then underlying graph will have two versions of node “c”:“c 1” and “c2”. “c 1” is computed from “a” and “c2” is computed from “b”. Other nodes will have to be replicated as needed as well. Since we will have two versions of node “h”:“h1” and “h2” a node “j” from FIG. 2 can be computed as well.

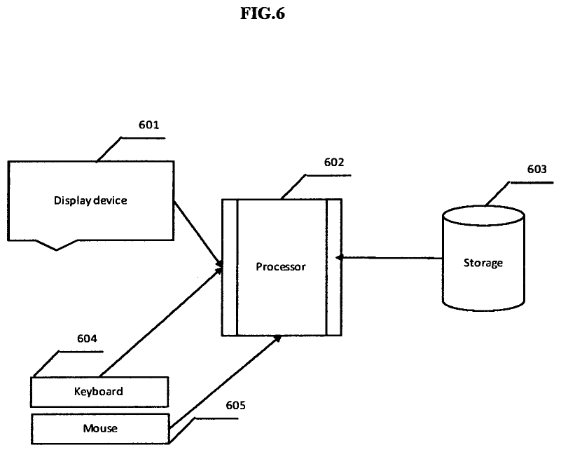

FIG. 6 illustrates a typical operating environment for embodiments of the present invention. 602 is an instruction execution or processing platform. The system includes a fixed storage medium, illustrated graphically at 603, for storing programs that make up computer program code, which enables the modeling algorithm and any other calculations that may be used with the embodiment of the invention. Instruction execution platform 602 of FIG. 6 can execute the appropriate instructions and display appropriate screens on display device 601. These screens can include user input screens for entering various parameters, using such input devices as keyboard 604 and mouse 605.

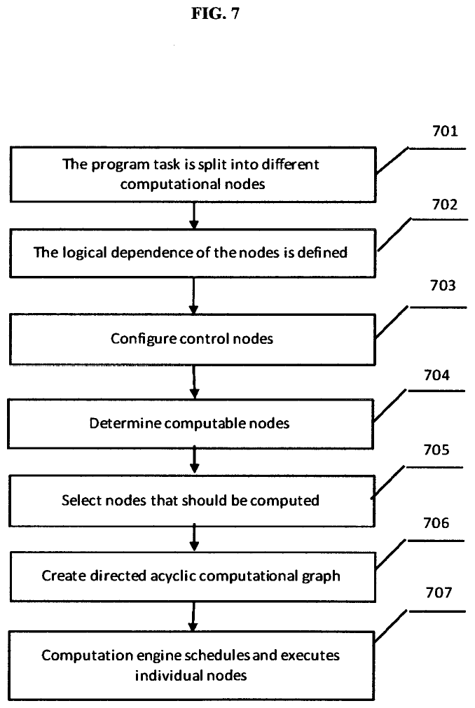

FIG. 7 illustrates non-limiting example of Boolean multi-flow method

1) The program task is split into different computational nodes as in 701. Each node is going to performs some computational task.

2) The logical dependence of the nodes is defined as in 702. The logic is expressed using any subset of the Boolean AND, OR, NOT operators or their equivalents. The nodes with their Boolean logic dependence form Boolean network.

3) The program starts and configures control nodes that determine what type of input data is going to be used as in 703. User can configure some of the nodes interactively during program execution.

4) The program determines the nodes that are computable for a given configuration of switches in 704 and selects the nodes that should be actually computed in 705. User can potentially select interactively what subset of computable nodes should actually be computed.

5) Given a list of nodes to compute the program creates directed acyclic computational graph and computes the results as in 706. The task scheduler will figure out all intermediate nodes that need to be computed to get your final result and the order of execution.

### CONCLUSION

The forgoing description of embodiments has been presented for purposes of illustration and description of the Boolean Multi-flow programming. The foregoing description of the Boolean Multi-flow programming is not intended to be exhaustive or to limit embodiments to the precise form explicitly described or mentioned herein. Modifications and variations are possible in light of the above teachings or may be acquired from practice of various embodiments.

Some steps illustrated in the figures could be optional or could be performed in a different order. The embodiments described herein were chosen in order to describe the principals of various embodiments, their nature and the practical application to enable one skilled in the art to make and use these and other embodiments with various modification as are suited for the particular use contemplated. Any and all permutations of features from the above described embodiments are there within the scope of the invention.

Although the subject matter has been described in language specific to structural feature and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of writing and executing computer programs, the method comprising:
conducting, by a computer system, a number of computer-implemented calculations implemented as a series of nodes with node dependencies defined by Boolean functions or logical expressions, wherein the computer system comprises a processor and computer-readable medium, and is programmed to perform calculations;

2. The method of claim 1, wherein the computer system comprises a personal computer.

3. The method of claim 1, wherein the computer system comprises a server.

4. The method of claim 1, wherein the computer system comprises a computational device such as smart phone, Ipad, tablet or smart watch.

5. A computer-readable, non-transitory, tangible medium having computer executable instructions for performing a computer implemented method for executing of any program as a series of node computations with node dependencies defined by Boolean functions or other logical expressions.

6. The method of claim 1, wherein a two-valued or many-valued logic is used to define computational node dependence.

7. The method of claim 1, wherein a Boolean language compiler or interpreter is used to read Boolean or logical expressions that define node dependence and converts them into a suitable representation readable by work scheduler.

8. The method of claim 1, wherein a computation engine or work scheduler transforms logical node dependence into directed acyclic graph.

9. The method of claim 1, wherein a computation engine or work scheduler creates, as necessary, additional copies of the nodes corresponding to alternative ways of computing them in order to accommodate simultaneous calculation of several sets of inputs.
